(19) United States
(12) Patent Application Publication
(10) Pub. No.: US 2026/0124542 A1
(43) Pub. Date: May 7, 2026

(54) COLLISION BODY CONFIGURATION FOR VIRTUAL ITEM

(71) Applicant: Tencent Technology (Shenzhen) Company Limited, Shenzhen (CN)

(72) Inventors: Huiying LIN, Shenzhen (CN); Bing LIU, Shenzhen (CN); Zhenyu LI, Shenzhen (CN)

(73) Assignee: Tencent Technology (Shenzhen) Company Limited, Shenzhen (CN)

(21) Appl. No.: 19/440,559

(22) Filed: Jan. 5, 2026

Related U.S. Application Data
(63) Continuation of application No. PCT/CN2024/117900, filed on Sep. 10, 2024.

(30) Foreign Application Priority Data
Sep. 12, 2023 (CN) 202311177022.0

(51) Int. Cl. A63F 13/63; A63F 13/577; G06F 3/04842

(52) U.S. Cl. CPC A63F 13/63; A63F 13/577; G06F 3/04842

(57) ABSTRACT

In a collision body setting method of a virtual item, a construction interface of a user generated content (UGC) editor is output for display. The construction interface includes a virtual item construction element of a virtual item to be constructed in a virtual environment. The UGC editor is configured to generate at least two levels of candidate collision bodies for the virtual item. A setting operation that indicates a first level of candidate collision body among the at least two levels of candidate collision bodies to be associated with a collision body of the virtual item is obtained. The collision body of the virtual item is output for display based on the setting operation.

### RELATED APPLICATIONS

The present application is a continuation of International Application No. PCT/CN2024/117900, filed on September 10, 2024, which claims priority to Chinese Patent Application No. 202311177022.0, filed on September 12, 2023. The entire disclosures of the prior applications are hereby incorporated by reference.

### FIELD OF THE TECHNOLOGY

This application relates to the field of computer technologies, including a collision body setting method of a virtual item.

### BACKGROUND OF THE DISCLOSURE

Collision detection is used to detect whether a plurality of virtual items in a virtual environment intersect with each other.

In related art, a collision body refers to a region of a virtual item in a virtual environment that participates in collision detection. The collision body of the virtual item is created according to a three-dimensional shape of the virtual item, whereby a physical collision in the real world is simulated for the virtual item in the virtual environment.

However, the foregoing manner for setting a collision body is relatively simple.

### SUMMARY

Aspects of this disclosure provide a method for setting a collision body of a virtual item, an information processing apparatus, and a non-transitory computer-readable storage medium. Examples of technical solutions of this disclosure may be implemented as follows:

An aspect of this disclosure provides a collision body setting method of a virtual item. In the method, a construction interface of a user generated content (UGC) editor is output for display. The construction interface includes a virtual item construction element of a virtual item to be constructed in a virtual environment. The UGC editor generates at least two levels of candidate collision bodies for the virtual item. A setting operation that indicates a first level of candidate collision body among the at least two levels of candidate collision bodies to be associated with a collision body of the virtual item is obtained. The collision body of the virtual item is output for display based on the setting operation. A quantity of vertices of an i^{th}-level candidate collision body of the at least two levels of candidate collision bodies is a first quantity. A quantity of vertices of an (i+1)^{th}-level candidate collision body of the at least two levels of candidate collision bodies is a second quantity. The first quantity is greater than the second quantity, i being a positive integer smaller than a total quantity of the candidate collision bodies.

An aspect of this disclosure provides an information processing apparatus. The apparatus includes processing circuitry configured to output for display a construction interface of a user generated content (UGC) editor. The construction interface includes a virtual item construction element of a virtual item to be constructed in a virtual environment. The UGC editor is configured to generate at least two levels of candidate collision bodies for the virtual item. The processing circuitry is configured to obtain a setting operation that indicates a first level of candidate collision body among the at least two levels of candidate collision bodies to be associated with a collision body of the virtual item. The processing circuitry is configured to output for display the collision body of the virtual item based on the setting operation. A quantity of vertices of an i^{th}-level candidate collision body of the at least two levels of candidate collision bodies is a first quantity. A quantity of vertices of an (i+1)^{th}-level candidate collision body of the at least two levels of candidate collision bodies is a second quantity. The first quantity is greater than the second quantity, i being a positive integer smaller than a total quantity of the candidate collision bodies.

An aspect of this disclosure provides a collision body setting method of a virtual item. The method is performed by a terminal, the terminal runs a game program, the game program has a user-generated content (UGC) editor, and the UGC editor is at least configured to enable creation of a user-defined virtual environment. The method includes: displaying a construction interface of the UGC editor, the construction interface including at least one virtual item configured for constructing a virtual environment, and the UGC editor providing at least two levels of candidate collision bodies for the virtual item; obtaining a setting operation for the virtual item, the setting operation being configured for indicating that a first candidate collision body in the at least two levels of candidate collision bodies is determined as a collision body of the virtual item; and displaying the collision body of the virtual item in response to the setting operation, a quantity of vertexes of an i^{th}-level candidate collision body in the at least two levels of candidate collision bodies being a first quantity, a quantity of vertexes of an (i+1)^{th}-level candidate collision body in the at least two levels of candidate collision bodies being a second quantity, the first quantity being greater than the second quantity, and i being a positive integer less than a quantity of candidate collision bodies.

An aspect of this disclosure provides a collision body setting apparatus of a virtual item. The apparatus runs a game program, the game program has a UGC editor, and the UGC editor is at least configured to enable creation of a user-defined virtual environment. The apparatus includes: a display module, configured to display a construction interface of the UGC editor, the construction interface including at least one virtual item configured for constructing a virtual environment, and the UGC editor providing at least two levels of candidate collision bodies for the virtual item; and an obtaining module, configured to obtain a setting operation for the virtual item, the setting operation being configured for indicating that a first candidate collision body in the at least two levels of candidate collision bodies is determined as a collision body of the virtual item, the display module being further configured to display the collision body of the virtual item in response to the setting operation; and a quantity of vertexes of an i^{th}-level candidate collision body in the at least two levels of candidate collision bodies being a first quantity, a quantity of vertexes of an (i+1)^{th}-level candidate collision body in the at least two levels of candidate collision bodies being a second quantity, the first quantity being greater than the second quantity, and i being a positive integer less than a quantity of candidate collision bodies.

An aspect of this disclosure provides a computer device. The computer device includes a processor and a memory, the memory has at least one instruction, at least one program, a code set, or an instruction set stored therein, and the at least one instruction, the at least one program, the code set, or the instruction set is loaded and executed by the processor to implement the collision body setting methods of a virtual item according to the foregoing aspects.

An aspect of this disclosure provides a non-transitory computer-readable storage medium storing instructions which, when executed by a processor, cause the processor to implement the collision body setting methods of a virtual item according to the foregoing aspects.

An aspect of this disclosure provides a computer program product. The computer program product includes computer instructions, the computer instructions are stored in a computer-readable storage medium, and a processor reads the computer instructions from the computer-readable storage medium and executes the computer instructions, to implement the collision body setting methods of a virtual item according to the foregoing aspecst.

The technical solutions provided in the aspects of this disclosure achieve the following beneficial effects.

By providing the at least two levels of candidate collision bodies for the virtual item, a determination manner of the collision body of the virtual item is expanded. The at least two levels of candidate collision bodies correspond to different quantities of vertexes, whereby the at least two levels of candidate collision bodies correspond to different amounts of occupied computational resources. In this way, the computational resource occupation can be adjusted based on different quantities of vertexes, and a purpose of flexibly configuring collision bodies to terminals with different computing capabilities can be achieved.

### BRIEF DESCRIPTION OF THE DRAWINGS

FIG. 1 is a structural block diagram of a computer system according to an aspect of this disclosure.

FIG. 2 is a schematic diagram of a collision body setting method of a virtual item according to an aspect of this disclosure.

FIG. 3 is a flowchart of a collision body setting method of a virtual item according to an aspect of this disclosure.

FIG. 4 is a flowchart of a collision body setting method of a virtual item according to an aspect of this disclosure.

FIG. 5 is a schematic diagram of a collision body of a virtual item according to an aspect of this disclosure.

FIG. 6 is a flowchart of a collision body setting method of a virtual item according to an aspect of this disclosure.

FIG. 7 is a flowchart of a collision body setting method of a virtual item according to an aspect of this disclosure.

FIG. 8 is a schematic diagram of a collision body of a virtual item according to an aspect of this disclosure.

FIG. 9 is a flowchart of a collision body setting method of a virtual item according to an aspect of this disclosure.

FIG. 10 is a schematic diagram of a virtual tree according to an aspect of this disclosure.

FIG. 11 is a schematic diagram of a virtual tree according to an aspect of this disclosure.

FIG. 12 is a schematic diagram of a virtual item according to an aspect of this disclosure.

FIG. 13 is a flowchart of a collision body setting method of a virtual item according to an aspect of this disclosure.

FIG. 14 is a schematic diagram of a collision body of a virtual jump platform according to an aspect of this disclosure.

FIG. 15 is a schematic diagram of detecting a virtual item according to an aspect of this disclosure.

FIG. 16 is a schematic diagram of a first space according to an aspect of this disclosure.

FIG. 17 is a schematic diagram of a collision body setting method of a virtual item according to an aspect of this disclosure.

FIG. 18 is a flowchart of a collision body setting method of a virtual item according to an aspect of this disclosure.

FIG. 19 is a flowchart of a collision body setting method of a virtual item according to an aspect of this disclosure.

FIG. 20 is a structural block diagram of a collision body setting apparatus of a virtual item according to an aspect of this disclosure.

FIG. 21 is a structural block diagram of a terminal according to an aspect of this disclosure.

### DETAILED DESCRIPTION

To make the objectives, technical solutions, and advantages of this disclosure clearer, the following describes implementations of this disclosure in further detail with reference to the accompanying drawings. The descriptions of the terms are provided as examples and are not intended to limit the scope of the disclosure.

Example aspects are described in further detail herein, and examples of the aspects are shown in the accompanying drawings. When the following description involves the accompanying drawings, unless otherwise indicated, the same numerals in different accompanying drawings represent the same or similar elements. The implementations described in the following aspects do not represent all implementations consistent with this disclosure. On the contrary, the implementations are merely examples of apparatuses and methods and are consistent with some aspects of this disclosure.

The terms used in this disclosure are for the purpose of describing example aspects only and are not intended to limit this disclosure. The singular forms "a", "the", and "this" used in this disclosure and the appended claims are intended to include the plural forms as well, unless the context indicates otherwise. The term "and/or" used herein indicates and includes any or all possible combinations of one or more associated listed items.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Although the terms such as "first", "second", and "third" may be used in this disclosure to describe various information, the information is not limited to these terms. These terms are merely used to distinguish between information of the same type. For example, a first parameter may be referred to as a second parameter, and similarly, the second parameter may be referred to as the first parameter without departing from a scope of this disclosure. Depending on the context, for example, the word "if" used herein may be interpreted as "while" or "when" or "in response to determination".

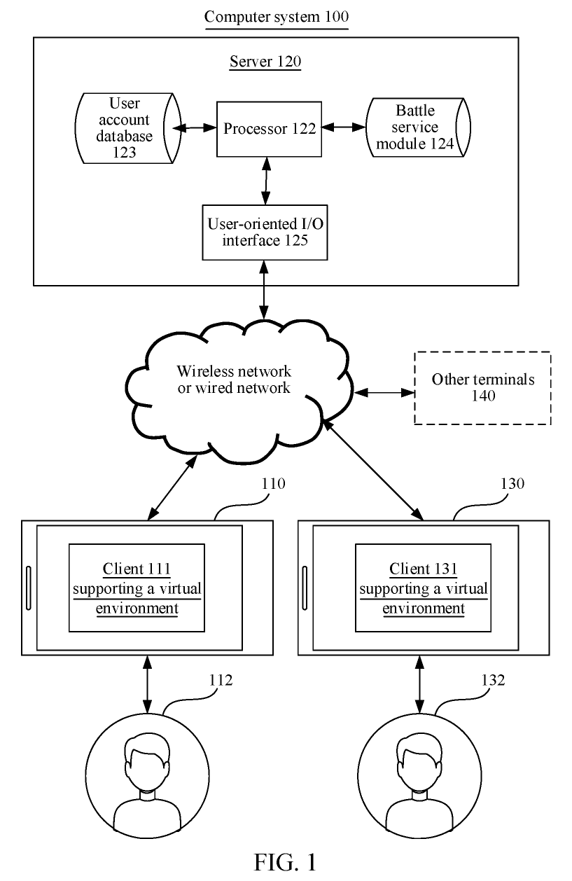

FIG. 1 is a structural block diagram of a computer system according to an aspect of this disclosure. The computer system 100 includes: a first terminal 110, a server 120, and a second terminal 130.

The first terminal 110 is equipped with and runs a client 111 supporting a virtual environment. The client 111 may be a multiplayer online battle program. When the first terminal 110 runs the client 111, a user interface of the client 111 is displayed on a screen of the first terminal 110. The client 111 may be any one of a battle royale shooting game, a virtual reality (VR) application program, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG), a sandbox building game, a casual game, and a level-based game. In an aspect, a description is made by using an example in which the client 111 is an FPS game. The first terminal 110 is a terminal used by a first user 112. The first user 112 uses the first terminal 110 to control a first virtual object in a virtual environment to perform activities. The first virtual object may be referred to as a virtual object of the first user 112. The activities of the first virtual object include, but are not limited to, at least one of moving, jumping, teleporting, casting a skill, using an item, adjusting a body posture, crawling, walking, running, riding, flying, leaping, driving, picking up, shooting, attacking, and throwing. For example, the first virtual object is a first virtual character such as a simulated personal character or a cartoon personal character.

The second terminal 130 is equipped with and runs a client 131 supporting a virtual environment. The client 131 may be a multiplayer online battle program. When the second terminal 130 runs the client 131, a user interface of the client 131 is displayed on a screen of the second terminal 130. The client 131 may be any one of a battle royale shooting game, a VR application program, an AR program, a three-dimensional map program, a VR game, an AR game, an FPS game, a TPS game, a MOBA game, or an SLG. In an aspect, a description is made by using an example in which the client is an MOBA game. The second terminal 130 is a terminal used by a second user 132. The second user 132 uses the second terminal 130 to control a second virtual object in a virtual environment to perform activities, and the second virtual object may be referred to as a virtual object of the second user 132. For example, the second virtual object is a second virtual character such as a simulated personal character or a cartoon personal character.

In an aspect, the first virtual object and the second virtual object are in the same virtual environment. In some aspects, the first virtual object and the second virtual object may belong to the same faction, same team, same organization, have a friend relationship, or possess temporary communication permissions. In some other aspects, the first virtual object and the second virtual object may belong to different factions, different teams, and different organizations, or have an adversarial relationship.

In an aspect, the clients deployed on the first terminal 110 and the second terminal 130 are the same, or the clients deployed on the two terminals are the same type of clients on different operating system platforms (Android or IOS). The first terminal 110 may refer to one of a plurality of terminals, and the second terminal 130 may refer to another one of the plurality of terminals. In the aspects of this disclosure, a description is made by taking only the first terminal 110 and the second terminal 130 as an example. A device type of the first terminal 110 and a device type of the second terminal 130 may be the same or different. The device type includes at least one of a smartphone, a tablet computer, an e-book reader, a Moving Picture Experts Group Audio Layer III (MP3) player, a Moving Picture Experts Group Audio Layer IV (MP4) player, a laptop computer, and a desktop computer.

FIG. 1 only shows two terminals. However, in different aspects, there may be one or more other terminals 140 that can access the server 120. In an aspect, the one or more other terminals 140 may be terminals corresponding to developers. A development and editing platform for a client that supports a virtual environment is deployed on the terminal 140. The developer may edit and update the client on the terminal 140, and transmit an updated client installation package to the server 120 over a wired or wireless network. The first terminal 110 and the second terminal 130 may download the client installation package from the server 120 to update the clients.

The first terminal 110, the second terminal 130, and the other terminals 140 are connected to the server 120 through the wireless network or wired network.

The server 120 includes at least one of one server, a plurality of servers, a cloud computing platform, and a virtualization center. The server 120 is configured to provide a backend service for the client supporting the virtual environment. In an aspect, the server 120 is in charge of primary computing works, and the terminal is in charge of secondary computing works; alternatively, the server 120 is in charge of the secondary computing works, and the terminal is in charge of the primary computing works; and alternatively, the server 120 and the terminal perform collaborative computing based on a distributed computing architecture.

For example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the other terminals 140, such as avatars of the user accounts, nicknames of the user accounts, fighting power indexes of the user accounts, and service areas of the user accounts. The battle service module 124 is configured to provide a plurality of battle rooms for users to battle, such as a 1V1 battle room, a 3V3 battle room, or a 5V5 battle room. The user-oriented I/O interface 125 is configured to establish communication with the first terminal 110 and/or the second terminal 130 via a wireless network or wired network for data exchange.

The method provided in the aspects of this disclosure may be applied to, but is not limited to, at least one of the following scenarios: a VR application program, a three-dimensional map program, an FPS game, a TPS game, an MOBA game, a multiplayer gunfight survival game, and the like. The following aspects are described by using an example in which the method is applied to a game.

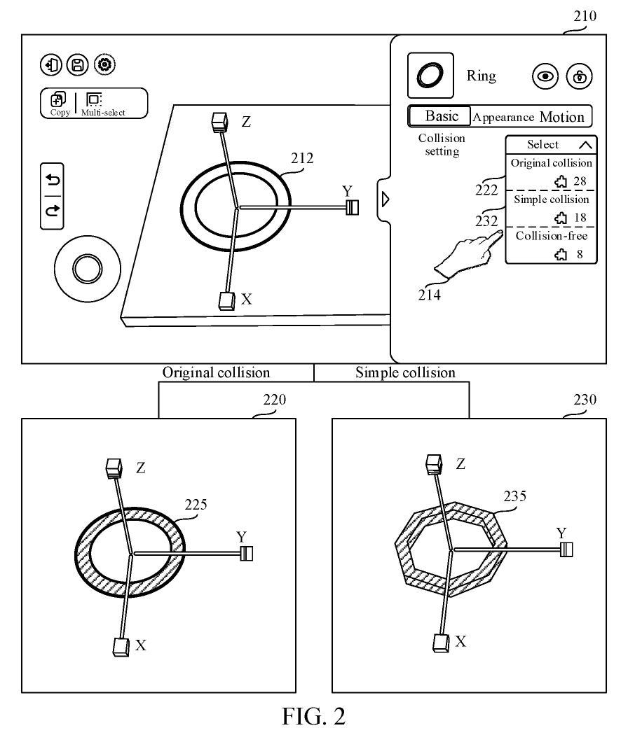

FIG. 2 is a schematic diagram of a collision body setting method of a virtual item according to an aspect of this disclosure.

A first interface 210 is a construction interface provided by a user-generated content (UGC) editor in a game program run on a terminal. For example, the UGC editor is configured to enable creation of a user-defined virtual environment by allowing a user to create a virtual item on the construction interface. In the created user-defined virtual environment, a virtual character can be controlled to perform at least one of virtual activities such as moving, jumping, lying, climbing, and running.

For example, the construction interface provided by the UGC editor includes a virtual ring 212 configured for constructing the virtual environment, a setting operation 214 for the virtual ring 212 is obtained, and a collision body of the virtual ring 212 is determined.

For example, the UGC editor provides, for the virtual ring 212, at least two levels of candidate collision bodies having different amounts of occupied computational resources.

In response to the setting operation 214 being a trigger operation for a first selection control 222, the virtual ring 212 is determined, in an original collision manner, as a first-level candidate collision body corresponding to the first selection control 222, and the first-level candidate collision body 225 is displayed on a second interface 220.

In response to the setting operation 214 being a trigger operation for a second selection control 232, the virtual ring 212 is determined, in a simple collision manner, as a second-level candidate collision body corresponding to the first selection control 222, and the second-level candidate collision body 235 is displayed on a third interface 230.

For example, the original collision manner is configured for determining the first-level candidate collision body 225, and the simple collision manner is configured for determining the second-level candidate collision body 235. The original collision manner and the simple collision manner are in one-to-one correspondence with two levels of candidate collision bodies with different amounts of occupied computational resources, whereby collision body determination manners corresponding to different amounts of occupied resources are provided. In an example, a positive correlation exists between an amount of occupied computational resources and a quantity of vertexes of a collision body, and different quantities of vertexes of collision bodies correspond to different amounts of occupied computational resources. For example, a quantity of vertexes of the first-level candidate collision body 225 is a first quantity, a quantity of vertexes of the second-level candidate collision body 235 is a second quantity, and the first quantity is greater than the second quantity.

For example, a collision-free manner is configured for indicating a collision body without the virtual ring 212, and the at least two levels of candidate collision bodies provided by the UGC editor are configured for indicating that in a case that a collision body exists, different levels of candidate collision bodies correspond to different amounts of occupied computational resources.

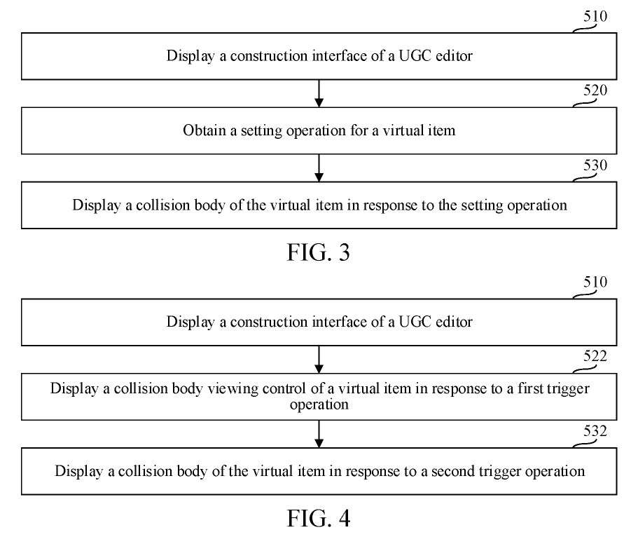

FIG. 3 is a flowchart of a collision body setting method of a virtual item according to an aspect of this disclosure. A description is made by using an example in which the method is applied to a terminal. The method includes operation 510 to operation 530.

Operation 510: Display a construction interface of a UGC editor. For example, a construction interface of a user generated content (UGC) editor is output for display. The construction interface includes a virtual item construction element of a virtual item to be constructed in a virtual environment. The UGC editor generates at least two levels of candidate collision bodies for the virtual item.

For example, the terminal runs a game program, the game program has a UGC editor, and the UGC editor is at least configured to enable creation of a user-defined virtual environment. For example, the UGC editor provides a construction interface, and enables creation of a user-defined virtual environment by creating a virtual item on the construction interface.

For example, the construction interface of the UGC editor includes at least one virtual item configured for constructing a virtual environment. For example, the virtual item may be a virtual three-dimensional shape such as a sphere, a prism, a pyramid, a cylinder, or a cone, or may be a pre-constructed model of a virtual item such as a virtual house, a virtual vehicle, or a virtual tree. This is not limited in the aspects of this disclosure.

For example, the UGC editor provides at least two levels of candidate collision bodies for the virtual item, and the at least two levels of candidate collision bodies correspond to different amounts of occupied computational resources. For example, the amount of occupied computational resources is configured for indicating an amount of computational resources that need to be occupied for performing collision detection on a virtual item. For example, the amount of occupied computational resources may be directly displayed on the construction interface, or may be attribute information of the virtual item, and the amount of occupied computational resources is indicated by using at least one of a loading time of the virtual item and an amount of occupied resources of the virtual item.

Operation 520: Obtain a setting operation for a virtual item. For example, a setting operation that indicates a first level of candidate collision body among the at least two levels of candidate collision bodies to be associated with a collision body of the virtual item is obtained.

For example, the setting operation is configured for indicating that a first candidate collision body in the at least two levels of candidate collision bodies is determined as a collision body of the virtual item. For example, the first candidate collision body is any candidate collision body in the at least two levels of candidate collision bodies.

For example, an implementation of the setting operation includes, but is not limited to, at least one of the following: clicking/tapping, sliding, and rotation, such as tapping a touchscreen or a button, sliding a touchscreen or a handle, or rotating a terminal or a handle.

Operation 530: Display a collision body of the virtual item in response to the setting operation. For example, the collision body of the virtual item is output for display based on the setting operation. A quantity of vertices of an i^{th}-level candidate collision body of the at least two levels of candidate collision bodies is a first quantity. A quantity of vertices of an (i+1)^{th}-level candidate collision body of the at least two levels of candidate collision bodies is a second quantity. The first quantity is greater than the second quantity, i being a positive integer smaller than a total quantity of the candidate collision bodies.

For example, the collision body is configured for simulating a three-dimensional shape of the virtual item, and the collision body is the first candidate collision body in the at least two levels of candidate collision bodies. For example, the at least two levels of candidate collision bodies are configured for simulating the three-dimensional shape of the virtual item based on different amounts of occupied computational resources. For example, the collision body and the virtual item may be displayed at the same time, to compare three-dimensional shapes of the collision body and the virtual item. Alternatively, the collision body and the virtual item may be separately displayed. For example, the collision body is displayed instead of the virtual item on the construction interface.

For example, a quantity of vertexes of an i^{th}-level candidate collision body in the at least two levels of candidate collision bodies is a first quantity, a quantity of vertexes of an (i+1)^{th}-level candidate collision body in the at least two levels of candidate collision bodies is a second quantity, the first quantity is greater than the second quantity, and i is a positive integer less than a quantity of candidate collision bodies. In an example, an amount of occupied computational resources of the candidate collision body is positively correlated with a quantity of vertexes of the candidate collision body, and the amount of occupied computational resources of the candidate collision body increases as the quantity of vertexes increases.

In conclusion, in the method provided in the aspects of this disclosure, by providing the at least two levels of candidate collision bodies for the virtual item, a determination manner of the collision body of the virtual item is expanded. The at least two levels of candidate collision bodies correspond to different quantities of vertexes, whereby the at least two levels of candidate collision bodies correspond to different amounts of occupied computational resources. In this way, the computational resource occupation can be adjusted based on different quantities of vertexes, and a purpose of flexibly configuring collision bodies to terminals with different computing capabilities can be achieved.

FIG. 4 is a flowchart of a collision body setting method of a virtual item according to an aspect of this disclosure. A description is made by using an example in which the method is applied to a terminal. That is, in the aspect shown in FIG. 3, operation 520 may be implemented as operation 522, and operation 530 may be implemented as operation 532.

Operation 522: Display a collision body viewing control of a virtual item in response to a first trigger operation. For example, a first trigger operation performed on a first selection control element of the construction interface is received.

In an aspect, a setting operation includes a first trigger operation for a first selection control and a second trigger operation for a collision body viewing control. For example, a collision body of a virtual item is displayed through the first trigger operation and the second trigger operation.

For example, a construction interface includes at least two candidate selection controls, and the at least two candidate selection controls are in one-to-one correspondence with at least two levels of candidate collision bodies. For example, the at least two candidate selection controls include the first selection control, and the first selection control corresponds to any candidate collision body in the at least two levels of candidate collision bodies. For example, the first selection control corresponds to a first candidate collision body. For example, the collision body viewing control is configured to provide a function entry for viewing the first candidate collision body corresponding to the first selection control.

For example, the first trigger operation is configured for determining the first candidate collision body in the at least two levels of candidate collision bodies as a collision body of the virtual item. The collision body viewing control is a viewing control corresponding to the first candidate collision body, and is configured to provide a function entry for viewing the first candidate collision body corresponding to the first selection control.

A UGC editor in the aspects of this disclosure provides at least two levels of candidate collision bodies for the virtual item, and a new determination manner of a collision body is expanded for user-defined creation of a virtual environment. A description is made by using an example in which a quantity of vertexes of a first-level candidate collision body in the at least two levels of candidate collision bodies is greater than a quantity of vertexes of a second-level candidate collision body.

By determining the collision body of the virtual item as the second-level candidate collision body, experience of performing a virtual activity in a virtual environment can be ensured when computational resources of a terminal are insufficient. Compared with the first-level candidate collision body, the quantity of vertexes of the second-level candidate collision body is reduced, whereby computational complexity of collision detection of the virtual item in the virtual environment is reduced, computational resources of the terminal are saved, and the problem of display stuttering, failure to display the virtual item, abnormal collision detection of the virtual item, or the like caused by insufficient computational resources of the terminal is avoided.

By determining the collision body of the virtual item as the first-level candidate collision body, an effect of simulating a physical collision in a virtual environment is optimized. Compared with the second-level candidate collision body, the quantity of vertexes of the first-level candidate collision body is increased, and the first-level candidate collision body better conforms to a three-dimensional structure of the virtual item, whereby an effect of simulating a physical collision during collision detection in the virtual environment is ensured, and the problem that collision effects of different collision bodies do not match visual effects of texture display of the virtual item, which is caused by an overly large gap between the collision body and the three-dimensional structure of the virtual item in a case that the virtual item has a complex three-dimensional structure, is avoided.

Operation 532: Display a collision body of the virtual item in response to a second trigger operation. For example, a second trigger operation performed on a collision body viewing control element of the construction interface is received. The construction interface includes (i) the first selection control element corresponding to a first level of candidate collision body of the at least two levels of candidate collision bodies, and (ii) a second selection control element corresponding to a second level of candidate collision body of the at least two levels of candidate collision bodies.

For example, the second trigger operation is a trigger operation for the collision body viewing control. The collision body is the first candidate collision body corresponding to the first trigger operation, and the displayed collision body is the first candidate collision body in the at least two levels of candidate collision bodies.

For example, an implementation of the first trigger operation and the second trigger operation includes, but is not limited to, at least one of the following: clicking/tapping, sliding, and rotation, such as tapping a touchscreen or a button, sliding a touchscreen or a handle, or rotating a terminal or a handle.

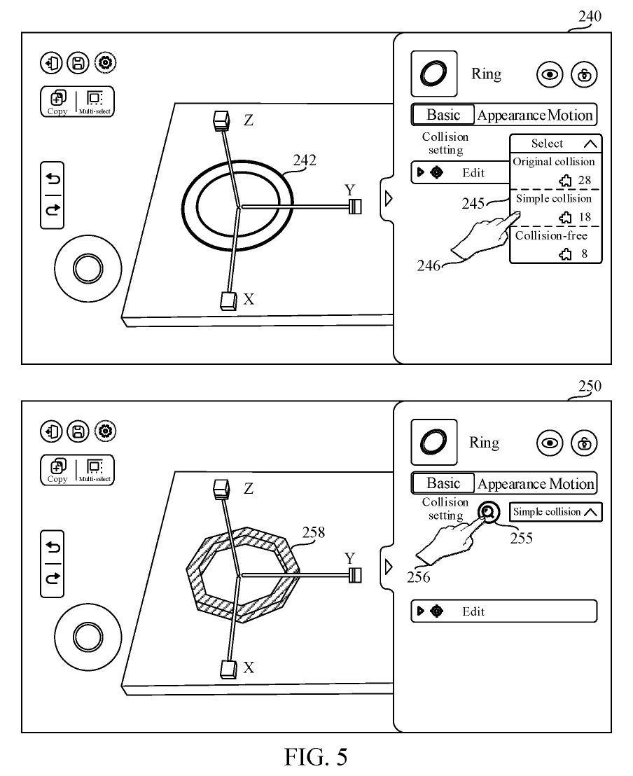

FIG. 5 is a schematic diagram of a collision body of a virtual item according to an aspect of this disclosure. A fourth interface 240 is a construction interface provided by a UGC editor in a game program run on a terminal. The construction interface includes a virtual ring 242 configured for constructing a virtual environment. A first trigger operation 246 for a first selection control 245 is obtained, and a collision body viewing control 255 of the virtual ring 242 is displayed on a fifth interface 250. A second trigger operation 256 for the collision body viewing control 255 is obtained, and a collision body 258 of a virtual item is displayed on the fifth interface 250.

In conclusion, in the method provided in the aspects of this disclosure, the purpose of setting the collision body of the virtual item is achieved through the first trigger operation, and the second trigger operation is performed when the collision body needs to be viewed, whereby a visual view of the collision body is achieved.

Next, a display manner of a collision body is described.

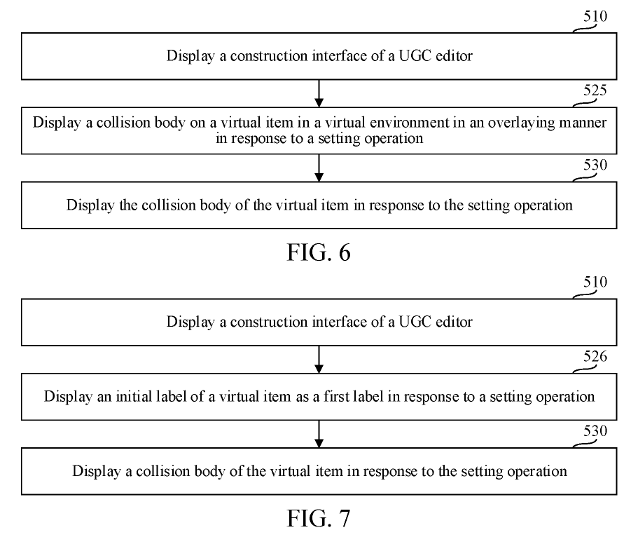

FIG. 6 is a flowchart of a collision body setting method of a virtual item according to an aspect of this disclosure. A description is made by using an example in which the method is applied to a terminal. That is, in the aspect shown in FIG. 3, operation 520 may be implemented as operation 525.

Operation 525: Display a collision body on a virtual item in a virtual environment in an overlaying manner in response to a setting operation. For example, the collision body with the virtual item is output for display in the virtual environment.

In an aspect, the virtual item is an item created in the virtual environment. In an example, a construction interface of a UGC editor includes a candidate region and a construction region, and the virtual item is a virtual item created in the construction region. The candidate region of the UGC editor provides at least one candidate item, and the virtual item and one candidate item have the same item type.

For example, by displaying the collision body on the virtual item in the virtual environment in an overlapping manner, the collision body corresponding to the virtual item can be directly displayed in the virtual environment, whereby a display manner for immersively viewing the collision body in the virtual environment is provided. It is convenient to compare distances between the collision body of the virtual item and other items around the virtual item in the virtual environment.

For example, the collision body displayed on the virtual item in an overlaying manner may be displayed in a translucent or covering manner. In an example, the collision body and a texture image of the virtual item have different colors. A collision body of another virtual item, such as another virtual item around the virtual item or all virtual items in the virtual environment, may further be displayed in the virtual environment.

In conclusion, in the method provided in the aspects of this disclosure, the collision body is displayed in an overlaying manner, whereby a display manner for viewing the collision body in the virtual environment is provided, and visual viewing of the collision body is achieved.

FIG. 7 is a flowchart of a collision body setting method of a virtual item according to an aspect of this disclosure. A description is made by using an example in which the method is applied to a terminal. That is, in the aspect shown in FIG. 3, operation 520 may be implemented as operation 526.

Operation 526: Display an initial label of a virtual item as a first label in response to a setting operation. For example, an initial label of the virtual item is output for display. The initial label indicates the virtual item corresponds to the collision body.

In an aspect, the virtual item is a candidate item provided on a construction interface. In an example, as described above, a construction interface of a UGC editor includes a candidate region and a construction region, and the virtual item is a virtual item in the candidate region, that is, the candidate item provided on the construction interface. In an aspect, the candidate item is dragged to the construction region, to create an environment constructing item in a virtual environment.

For example, the initial label of the virtual item is modified through the setting operation, and the initial label of the candidate item provided on the construction interface is determined as the first label. The first label is configured for indicating that the virtual item corresponds to a collision body. By modifying a default state of the candidate item, the created environment constructing item and the virtual item have the same collision body.

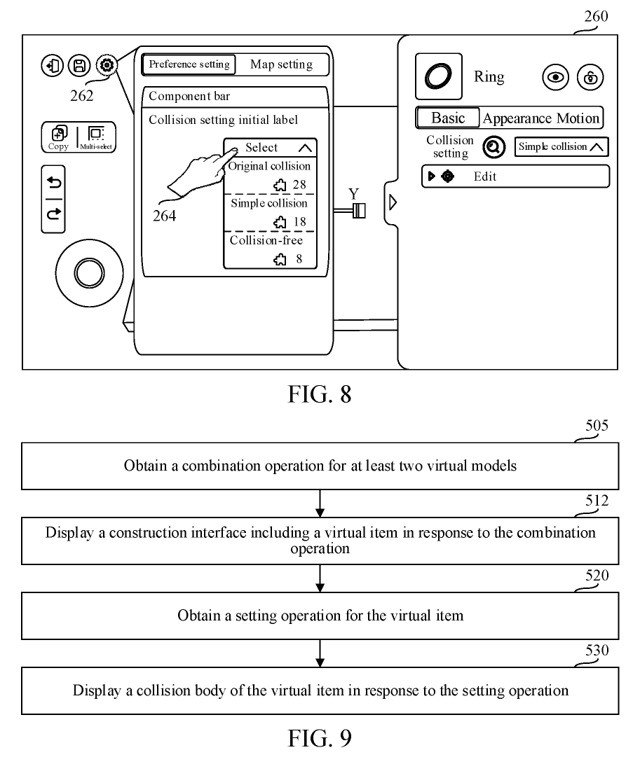

FIG. 8 is a schematic diagram of a collision body of a virtual item according to an aspect of this disclosure. A setting operation 264 on a sixth interface 260 is a setting operation for a UGC editor, which involves setting of collision bodies of one or more candidate items provided by the UGC editor. For example, the setting operation 264 is to set an initial label of a virtual item in preference setting of a setting entry 262 of the UGC editor. Similar to FIG. 2 described above, at least two levels of candidate collision bodies corresponding to different amounts of occupied computational resources are provided in the preference setting. In an example, the initial label of the virtual item is set to be a first label, whereby environment constructing items created in a virtual environment are all collision bodies corresponding to the first label.

In one implementation, this aspect further includes the following operations:

an environment constructing item is created in a virtual environment in response to obtaining a creation operation for a virtual item; and

a collision body of the environment constructing item is displayed in response to obtaining a viewing operation for the environment constructing item.

For example, a type of the environment constructing item is the same as a type of the virtual item. For example, the virtual item is dragged to a construction region, to create the environment constructing item in the virtual environment. For example, the collision body of the environment constructing item is a first candidate collision body corresponding to the setting operation, whereby a purpose of modifying the initial label of the virtual item through the setting operation is achieved.

The environment constructing item created based on the virtual item having the first label and the virtual item have the same collision body, whereby preference setting for the virtual item is achieved, setting collision bodies of created environment constructing items one by one in the virtual environment is avoided, and human-computer interaction efficiency is improved. In an example, the creation operation is obtained after the setting operation, and an initial collision region of the candidate virtual item on the construction interface is determined as the first candidate collision body through the setting operation.

In conclusion, in the method provided in the aspects of this disclosure, the initial label of the candidate item provided on the construction interface is determined as the first label. In this way, by modifying a default state of the candidate item, the created environment constructing item and the virtual item have the same collision body.

Next, a vertex of a collision body is further described.

In an example of this disclosure, the vertex of the collision body may be implemented in at least one of the following four implementations.

Implementation I: A vertex position of the collision body belongs to a subset of vertex positions of a virtual item.

For example, a first set of the vertex positions of the virtual item includes a second set of the vertex positions of the collision body. In this way, the collision body is restricted by a three-dimensional structure of the virtual item, which ensures that the collision body can accurately simulate the three-dimensional structure of the virtual item.

Implementation II: In a case that a first plane on which at least three vertexes of the collision body are located penetrates through the virtual item, a maximum distance between a first vertex of the virtual item and the first plane is less than a first distance threshold, and the first vertex is any vertex located on a side of the first plane.

For example, in a case that the first plane penetrates through the virtual item, parts of the collision body at the foregoing three vertexes are located inside the three-dimensional structure of the virtual item. The first distance threshold limits a degree to which the collision body is scaled down inside the three-dimensional structure of the virtual item. In this way, a difference between an excessively small collision body and the three-dimensional structure of the virtual item is avoided, to ensure that the collision body can accurately simulate the three-dimensional structure of the virtual item.

For example, in one implementation, the at least three vertexes of the collision body may include the first vertex, and the first plane is a plane in which a triangle that has a minimum area and that is formed by the first vertex and the other two vertexes on the collision body is located.

For example, the first distance threshold may be preset, or may be determined according to the area of the triangle formed by the at least three vertexes. For example, the first distance threshold is positively correlated with the area of the triangle.

Implementation III: In a case that a second plane on which at least three vertexes of the collision body are located does not penetrate through the virtual item, a minimum distance between a second vertex of the virtual item and the second plane is less than a second distance threshold, and the second vertex is any vertex on the virtual item.

For example, in a case that the second plane does not penetrate through the virtual item, parts of the collision body at the foregoing three vertexes are located outside a three-dimensional structure of the virtual item. The second distance threshold limits a degree to which the collision body is scaled up outside the three-dimensional structure of the virtual item. In this way, a difference between an excessively large collision body and the three-dimensional structure of the virtual item is avoided, to ensure that the collision body can accurately simulate the three-dimensional structure of the virtual item.

For example, in one implementation, the at least three vertexes of the collision body may include the second vertex, and the second plane is a plane in which a triangle that has a minimum area and that is formed by the second vertex and the other two vertexes on the collision body is located.

For example, the second distance threshold may be preset, or may be determined according to the area of the triangle formed by the at least three vertexes. For example, the second distance threshold is positively correlated with the area of the triangle.

Implementation IV: A distance between any two vertexes of the collision body is greater than a third distance threshold.

For example, the third distance threshold limits a minimum interval between vertexes on the collision body, to reduce an amount of computational resources occupied by the collision body. For example, the third distance threshold is positively correlated with a value of i in an i^{th}-level candidate collision body. The amount of computational resources occupied by the collision body decreases as the value of i increases, and the third distance threshold increases as the value of i increases.

In conclusion, in the method provided in the aspects of this disclosure, a position of the vertex of the collision body is limited by a constraint condition, which ensures that the collision body can accurately simulate the three-dimensional structure of the virtual item.

Next, a manner for constructing a collision body is described.

For example, the collision body is a three-dimensional region formed by at least one of a cuboid collision body, a spherical collision body, and a polygonal surface patch. For example, the collision body is formed by different collision bodies or polygonal surface patches, whereby construction complexity of the collision body can be reduced, and a three-dimensional structure of a virtual item can be accurately simulated.

For example, the collision body includes at least one of a cuboid collision body, a spherical collision body, and a polygonal surface patch. For example, a cuboid collision body, a spherical collision body, and a polygonal surface patch are separately described.

In one implementation of the aspects, in a case that the collision body includes the cuboid collision body, a vertex of the collision body includes a vertex of the cuboid collision body.

In another implementation of the aspects, in a case that the collision body includes the spherical collision body, a vertex of the collision body includes a vertex of the spherical collision body on coordinate axes of a three-dimensional coordinate system, and the three-dimensional coordinate system is established by taking a spherical center of the spherical collision body as an origin.

In still another implementation of the aspects, in a case that a surface of the collision body includes the polygonal surface patch, a vertex of the collision body includes a vertex of the polygonal surface patch. For example, the polygonal surface patch is a polygonal plane located on the surface of the collision body. In an example, the collision body is a three-dimensional region bounded by the polygonal surface patch. For example, the collision body is configured for simulating a three-dimensional structure of a virtual tree. Similar to a tree in the real world, the virtual tree has parts such as leaves and a tree trunk, and presents an irregular three-dimensional structure. Therefore, the polygonal surface patch may include a plurality of triangular surface patches, and the three-dimensional structure of the virtual tree is simulated by using a three-dimensional region bound by the plurality of triangular surface patches.

In conclusion, in the method provided in the aspects of this disclosure, the collision body is constructed by using different types of collision bodies, which simplifies the manner for constructing the collision body.

FIG. 9 is a flowchart of a collision body setting method of a virtual item according to an aspect of this disclosure. A description is made by using an example in which the method is applied to a terminal. That is, based on the aspect shown in FIG. 3, the method further includes operation 505, and operation 510 may be implemented as operation 512.

Operation 505: Obtain a combination operation for at least two virtual models. For example, a combination operation performed on at least two virtual models is obtained. The combination operation indicates that the at least two virtual models are grouped.

For example, the combination operation is configured for indicating that the at least two virtual models are grouped. For example, the virtual model is typically a virtual three-dimensional shape such as a sphere, a prism, a pyramid, a cylinder, or a cone, but is not excluded from being an item such as a virtual bow, a virtual bell, or a virtual window. In an example, the combination operation is configured for indicating that one cylinder model, three cone models, a virtual bow, and a virtual bell are combined, to construct a virtual tree.

Operation 512: Display a construction interface including a virtual item in response to the combination operation. For example, based on the combination operation, a combined virtual item construction element of a combined virtual item obtained by grouping the at least two virtual models is output for display.

For example, the virtual item is a combination obtained by grouping the at least two virtual models. In an example of operation 505, the virtual item is the virtual tree constructed through the combination operation.

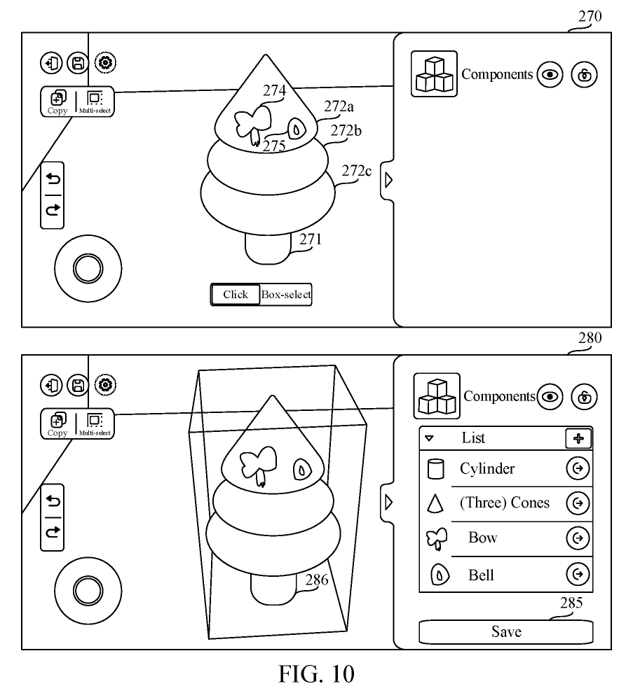

FIG. 10 is a schematic diagram of a virtual tree according to an aspect of this disclosure. A cylinder model 271, a first cone model 272a, a second cone model 272b, a third cone model 272c, a virtual bow 274, and a virtual bell 275 are displayed on a seventh interface 270. Peripheral frame lines of the foregoing virtual models are displayed on an eighth interface 280 by clicking or box-selecting the foregoing virtual models. By clicking a save control 285, the foregoing virtual models are combined into a virtual tree 286.

In one implementation of the aspects, a vertex of a collision body of a virtual item is a vertex on a surface of a three-dimensional region formed by collision bodies of the at least two virtual models. For example, the collision bodies of the at least two virtual models are combined into a communicated three-dimensional region, but a case that the collision bodies of the at least two virtual models are combined into a plurality of independent three-dimensional regions is not excluded either. By determining the vertex of the collision body on the surface of the three-dimensional region, overlaps between collision bodies of different virtual models inside the three-dimensional region are reduced, computational complexity of collision detection is reduced, and an amount of occupied computational resources is reduced.

In another implementation of the aspects, the vertex of the collision body of the virtual item is a vertex of a cuboid collision body. For example, a bottom surface of the cuboid collision body is a minimum bounding rectangle of a projection of the virtual item in a vertical direction, and at least one projection point of the virtual item is located on any side of the bottom surface of the cuboid collision body. A height of the cuboid collision body is a height of the virtual item, and each of the bottom surface and a top surface of the cuboid collision body has at least one intersection point with the virtual item. For example, by determining the collision body of the virtual item as a cuboid collision body, the collision body of the virtual item is simplified, an increased amount of occupied computational resources of the collision body, which is caused by a complex three-dimensional structure of a combination of a plurality of virtual models, is avoided, and it is ensured that the collision body can cover a three-dimensional space in which the combination of the plurality of virtual models is located.

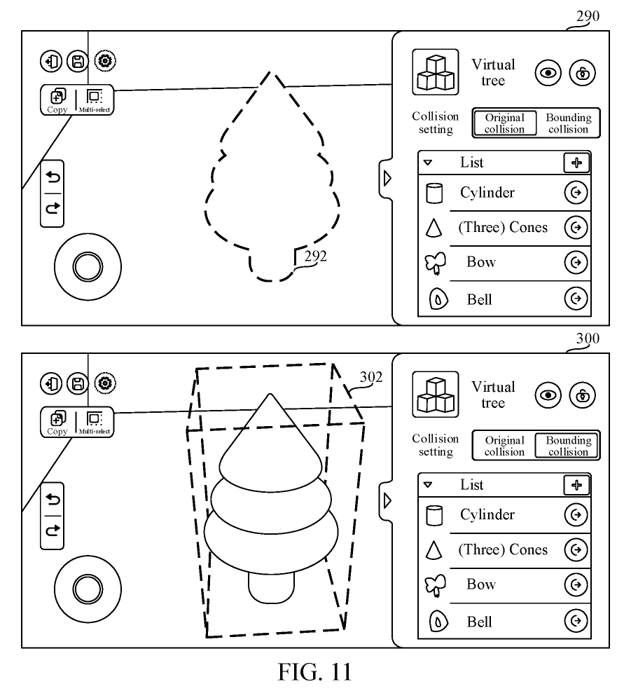

FIG. 11 is a schematic diagram of a virtual tree according to an aspect of this disclosure. For example, a ninth interface 290 shows that a vertex of a first collision body 292 of a virtual tree is a vertex on a surface of a three-dimensional region formed by collision bodies of a cylinder model, three cone models, a virtual bow, and a virtual bell. This manner for determining a collision body is referred to as an original collision manner. A tenth interface 300 shows that a vertex of a second collision body 302 of a virtual tree is a vertex of a cuboid collision body, and the cuboid collision body is a minimum bounding cuboid of a cylinder model, three cone models, a virtual bow, and a virtual bell. This manner for determining a collision body is referred to as a bounding collision manner.

In conclusion, in the method provided in the aspects of this disclosure, the virtual models are combined and a new virtual item is constructed through the combination operation.

In an example, a UGC editor provides, for a virtual item, at least two levels of candidate collision bodies corresponding to different amounts of occupied computational resources, and collision types corresponding to the two levels of candidate collision bodies are complex collision (also referred to as original collision) and simple collision, respectively.

For example, a virtual item in a virtual environment is also referred to as a component, which is a minimum unit in a user-defined virtual environment created by the UGC editor. Complex collision includes two cases. One corresponds to a primitive for collision within a mesh, namely, a basic shape (such as a triangle or a quadrangle) itself or one mesh formed by splicing a plurality of basic shapes, and the mesh may be taken as one collision body. The other case corresponds to a set of a plurality of simple shapes. A quantity of simple shapes in the set is relatively large, and the simple shapes (such as a polygonal surface patch) are more complex than the basic shape in the first case. These simple shapes jointly form an organization structure of a three-dimensional model, and are taken as one collision body. Simple collision corresponds to a user-defined primitive for collision within a mesh, that is, a minimum simple shape is customized to fit a collision body.

To be compatible with a plurality of types of collision details, for example, a user-defined primitive (also referred to as a user-defined collision) is added to a configuration of a static mesh. The user-defined primitive is configured for encapsulating simple collision data. That is, the user-defined primitive has collision data, and can replace another collision. Because collision is set at a granularity of a component, a member variable of a collision type is defined in a component attribute, to record a current collision type of the component. If a collision type change event is received, all static meshes in the component are obtained to form a static component, and a collision type used in the static component is cyclically set.

For example, because a combination formed by a plurality of virtual models is a logical component, and basic components that form the combination are not rendered, that is, there is only logical data and no physical component available for rendering, during customization of collision of the combination, a new static mesh component is created as a collision box for grouping. A size of the collision box is set to a bounding box in a spatial coordinate system of the combination, to generate a minimum bounding cuboid that encloses the entire combination. In addition, by using the static mesh component, the collision preview of a single component can be directly reused. Main rendering of a simple collision component is set to No. When the collision type of the combination is changed, if the collision type of the combination is changed to simple collision, first, collision of the plurality of virtual models inside the combination is closed, and the simple collision component of the combination is set to be collidable. If the collision type of the combination is changed to no collision, the simple collision component of the combination and the plurality of virtual models inside are all closed.

In an example, in a case that the virtual item is a combination, when a collision preview state of the combination is changed, if a collision type of the combination is complex collision, a collision preview state of a virtual model inside the combination is directly set. If the collision type of the combination is simple collision, first, the collision type of the combination is set to simple collision, and then, a simple collision component is set to main thread rendering, and is set to a corresponding preview state. The collision preview state is a view, and a collision body rather than a virtual item is rendered in this view.

In an example, a collision type field of the virtual item is stored in attributes of a component, and virtual environment data is serialized and stored in a bus interface module, along with stored attribute information of the virtual environment. A collision type is initialized by using a loading logic of a virtual environment, and the virtual environment data is restored to a mesh and a collision body.

For example, the UGC editor in the aspects of this disclosure provides, for a virtual item, at least two levels of candidate collision bodies corresponding to different amounts of occupied computational resources. In one design, for virtual light and shadow in a virtual environment, the UGC editor does not provide candidate collision bodies for the virtual light and shadow, and creates the virtual light and shadow in the virtual environment in a collision-free manner. For example, the virtual light and shadow includes, but is not limited to, at least one of virtual lightning, virtual rainbow, virtual sunlight, holographic projection, and the like. In another design, for a shape model in a virtual environment, the UGC editor provides one level of candidate collision body for the shape model. For example, the shape model is any one of a cube and a sphere. The cube or the sphere is a three-dimensional shape of a collision component when a collision body is constructed. In another design, for a virtual mechanism in a virtual environment, the UGC editor provides at least one level of candidate collision body for the virtual mechanism. For example, the virtual mechanism is a human-computer interaction mechanism in the virtual environment that is triggered by collision detection, such as at least one of mechanisms including a trampoline and a switch pedal.

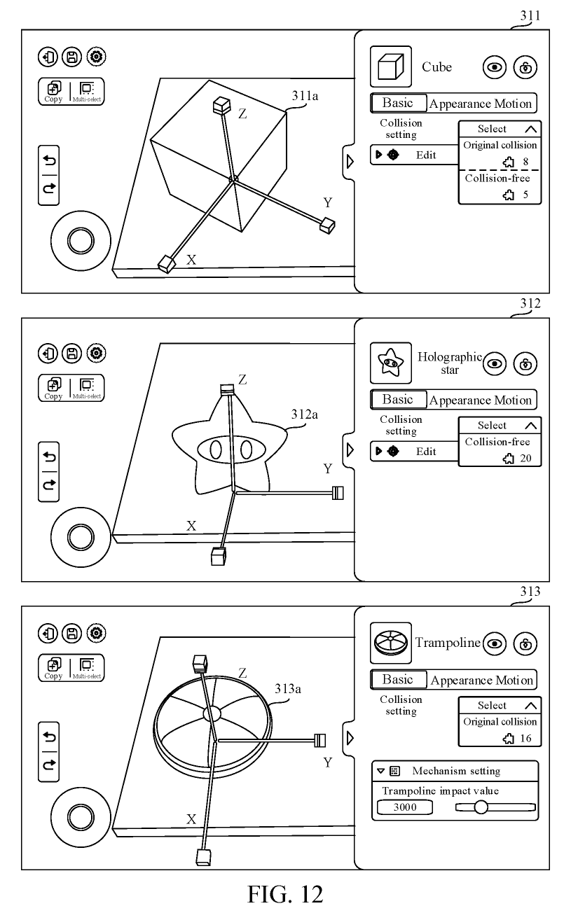

FIG. 12 is a schematic diagram of a virtual item according to an aspect of this disclosure. A virtual cube 311a is displayed on a tenth interface 311, one level of candidate collision body is provided for the virtual cube 311a, that is, a collision body of the virtual cube 311a is determined in an original collision manner, and a collision-free manner is configured for indicating that there is no collision body of the virtual cube 311a. A holographic star 312a is displayed on an eleventh interface 312, and no candidate collision body is provided for the holographic star 312a, that is, the holographic star 312a is created in a virtual environment in a collision-free manner. A virtual trampoline 313a is displayed on a twelfth interface 313, one level of candidate collision body is provided for the virtual trampoline 313a, that is, a collision body of the virtual trampoline 313a is determined in the original collision manner, and there is no setting for creating the virtual trampoline 313a in the collision-free manner indicating the absence of a collision body.

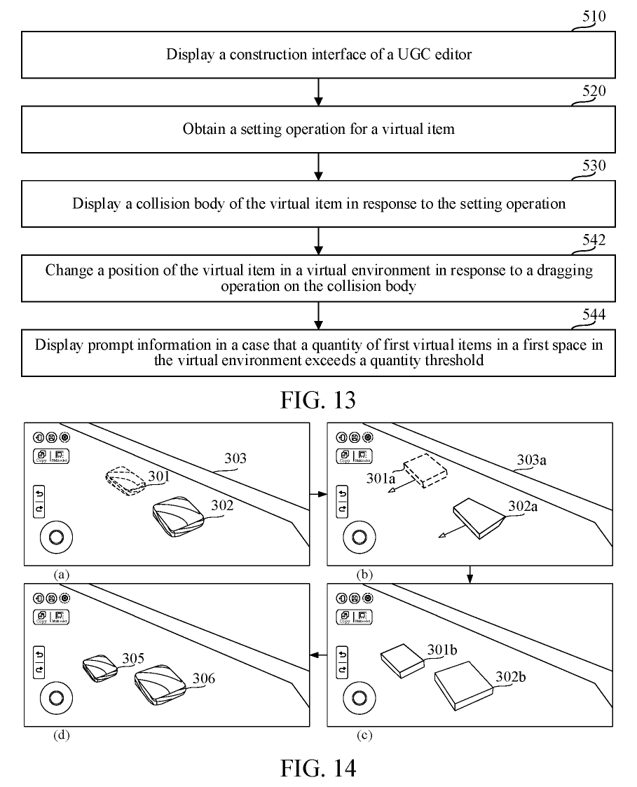

FIG. 13 is a flowchart of a collision body setting method of a virtual item according to an aspect of this disclosure. A description is made by using an example in which the method is applied to a terminal. For example, based on the aspect shown in FIG. 3, the method further includes operation 542 and operation 544.

Operation 542: Change a position of a virtual item in a virtual environment in response to a dragging operation for a collision body. For example, a position of the virtual item added to the virtual environment is changed based on a dragging operation performed on the collision body of the virtual item.

For example, the dragging operation is an operation for the collision body in a case that the collision body of the virtual item is displayed. In a case that the collision body is displayed, the position of the virtual item in the virtual environment is modified through the dragging operation. In an example, the collision body is displayed in the virtual environment, and in a case that the collision body is previewed, by moving the virtual item through a dragging operation, a position change of the collision body relative to a collision body of another virtual item in the virtual environment can be observed. In this way, the position of the virtual item is changed according to a position requirement of the collision body, and human-computer interaction efficiency is improved.

For example, by changing the position of the virtual item in the virtual environment, a new virtual item setting manner is expanded for the UGC editor. In this way, in a case that the virtual item is moved, the collision body is displayed, and a position change of the collision body as the virtual item is moved is viewed instantaneously.

Operation 542 in this aspect may be combined with operation 510 to operation 530 in FIG. 3 to form a new aspect for independent implementation. This is not limited in the aspects of this disclosure.

FIG. 14 is a schematic diagram of a collision body of a virtual jump platform according to an aspect of this disclosure. A virtual environment includes a first jump platform, a second jump platform, and a virtual wall. Sub-FIGURE(a) shows positions of a first jump platform 301, a second jump platform 302, and a virtual wall 303. Correspondingly, sub-FIGURE(b) shows corresponding collision bodies of the foregoing virtual items. The first jump platform 301 corresponds to a first collision body 301a, the second jump platform 302 corresponds to a second collision body 302a, and the virtual wall 303 corresponds to a third collision body 303a. A dragging operation is performed on the first collision body 301a and the second collision body 302a, respectively, in sub-FIGURE(b), to modify the positions of the first jump platform 301 and the second jump platform 302. Sub-FIGURE(c) shows a fourth collision body 301b and a fifth collision body 302b that are updated after the dragging operation is performed on the first collision body 301a and the second collision body 302a, respectively. Correspondingly, the positions of the first jump platform 301 and the second jump platform 302 are changed, and sub-FIGURE(d) shows an updated position 305 of the first jump platform and an updated position 306 of the second jump platform.

Operation 544: Display prompt information in a case that a quantity of first virtual items in a first space in the virtual environment exceeds a quantity threshold. For example, notification information is output for display based on a quantity of a plurality of virtual items in a first space of the virtual environment exceeding a quantity threshold. The notification information indicates that the quantity of virtual items exceeds the quantity threshold.

For example, the prompt information is alarm information indicating that the quantity of first virtual items exceeds the quantity threshold. The quantity threshold may be a preset threshold, or may be a threshold determined according to a computing capability of the terminal. Further, the quantity threshold is positively correlated with the computing capability of the terminal.

For example, the quantity threshold is a security threshold by which the first virtual item in the first space can be rendered and displayed when the first space in the virtual environment is displayed. The first space is a predefined space in the virtual environment, or a space selected by a user for rendering, and the first virtual item is a virtual item included in the first space. Further, the quantity threshold is a security threshold by which the first virtual item can be rendered and displayed according to at least one of a preset resolution, a preset frame rate, or a preset rendering time.

In one implementation of the aspects, operation 544 may be implemented as: displaying the prompt information in a case that a quantity of vertexes of a collision body of the first virtual item exceeds the quantity threshold.

For example, the quantity of vertexes of the collision body of the first virtual item indicates an amount of occupied computational resources for performing collision detection in the first space. Computational complexity of collision detection increases as the quantity of vertexes increases. In a case that the quantity of vertexes of the collision body of the first virtual item exceeds the quantity threshold, the amount of occupied computational resources for performing collision detection in the first space exceeds the safety threshold by which the first virtual item in the first space can be rendered and displayed.

In another implementation of the aspects, operation 544 may be implemented as: displaying the prompt information in a case that a data volume of texture resources of the first virtual item exceeds the quantity threshold.

For example, the data volume of the texture resources of the first virtual item indicates an amount of occupied computational resources for performing texture rendering on a surface of the first virtual item when the first space is observed. Computational complexity of performing texture rendering on the surface of the first virtual item increases as the data volume of the texture resources increases. In a case that the data volume of the texture resources of the first virtual item exceeds the quantity threshold, the amount of occupied computational resources for performing texture rendering on the surface of the first virtual item in the first space exceeds the security threshold by which the first virtual item in the first space can be rendered and displayed.

In one implementation of the aspects, a display manner of the prompt information includes at least one of the following: displaying the prompt information by using a highlighted mark of the first space, displaying the prompt information by using a pop-up window, displaying the prompt information by using a bubble, and displaying the prompt information by using a pop-up message card.

In an example, the highlighted mark is displayed in the first space in an overlaying manner. In an aspect, the highlighted mark includes at least one of a wireframe mark, a text mark, and a color highlighted mark.

Operation 544 in this aspect may be combined with operation 510 to operation 530 in FIG. 3 to form a new aspect for independent implementation. This is not limited in the aspects of this disclosure.

The prompt information may be automatically displayed in a case that the quantity of first virtual items in the first space in the virtual environment exceeds the quantity threshold. Alternatively, the quantity of first virtual items is detected in response to a detection operation for the virtual environment, and the prompt information is displayed in response to the quantity of first virtual items exceeding the quantity threshold.

In one implementation, the detection operation for the virtual environment is performed in a case that the virtual environment is published. For example, the prompt information is displayed in response to a publish operation for the virtual environment, and the created user-defined virtual environment is published as a virtual map in a game program through the publish operation; and the created user-defined virtual environment is detected in response to the publish operation, to determine whether the first virtual item in the first space can be rendered and displayed.

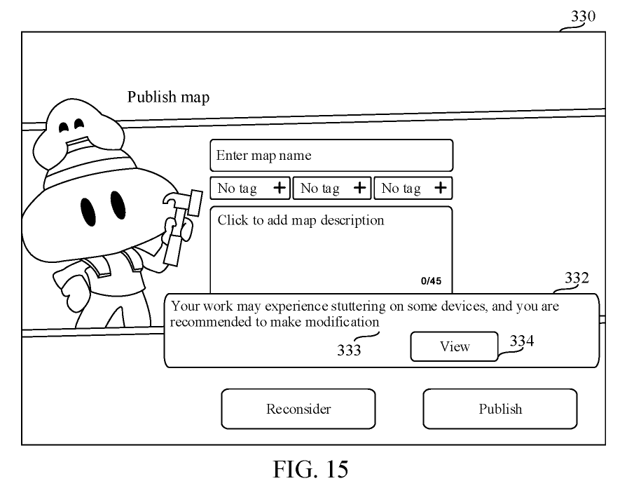

FIG. 15 is a schematic diagram of detecting a virtual item according to an aspect of this disclosure. Prompt information 332 is displayed on a published map interface 330, to prompt that a quantity of first virtual items in a first space in a virtual environment exceeds a security threshold by which rendering and displaying can be performed. For example, the prompt information 332 includes prompt text 333 and a jump control 334. The prompt text is text prompting that the quantity of first virtual items exceeds the security threshold by which rendering and displaying can be performed, such as "Your work may experience stuttering on some devices, and you are recommended to make modification". The first space exceeding the security threshold is displayed in response to triggering the jump control 334.

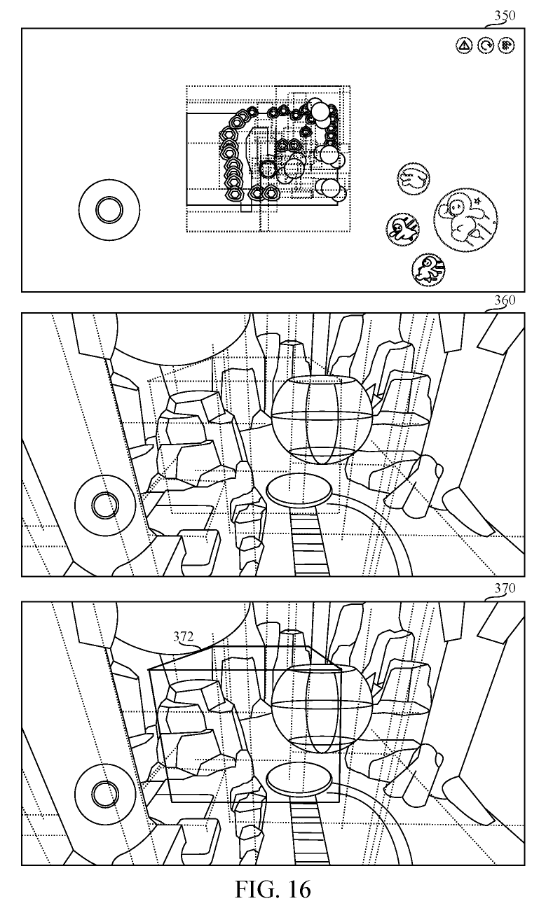

FIG. 16 is a schematic diagram of a first space according to an aspect of this disclosure. A first virtual environment interface 350 displays the first space in a virtual environment in a top view. A minimum bounding cuboid of a first virtual item in the first space is boxed in a dashed line manner, and the minimum bounding cuboid is obtained by dividing the first space in a K-dimensional (KD) tree manner, and is configured for displaying a density of the first virtual items in the first space. A second virtual environment interface 360 displays an observation result about the first space, and the first virtual item in the first space is displayed from a three-dimensional perspective. A third virtual environment interface 370 displays a highlighted mark 372 of the first space. The highlighted mark is displayed in a highlighted manner, and is also referred to as a hotspot region. However, displaying the highlighted mark in a manner, such as pattern filling or flickering, is not excluded. For example, a schematic diagram of the first space displayed on the terminal may only display the first virtual item in the first space, and does not display the minimum bounding cuboid of the first virtual item that is boxed in the dashed line manner in FIG. 16. This is not limited in this aspect. In FIG. 16, the first space is displayed to enable quick location of a virtual space at a risk of failing to render and display in the virtual environment, to guide a user to make targeted adjustments to the virtual environment through a UGC editor. For example, the virtual environment is detected by triggering a detection control, and in a case that a first control has a rendering and displaying risk, the jump control is displayed, to provide a function entry for displaying the first space. In a case that no rendering and displaying risk exists, detection result text is displayed, to indicate that no risk is discovered temporarily.

In one implementation, the prompt information may be displayed in response to an amount of computational resources occupied by a virtual item in a virtual environment reaching a preset threshold. For example, when a user-defined virtual environment is created on a construction interface, in a case that an amount of computational resources occupied by a virtual item created in the virtual environment exceeds the preset threshold, whether a quantity of first virtual items in a first space in the virtual environment exceeds a quantity threshold is determined.

In one implementation, the prompt information is prompt information that is displayed for the first space in response to a detection operation for the virtual environment. For example, the detection operation is a trigger operation for a detection tool control on a construction interface of a UGC editor. The detection tool control provides a function entry for detecting a rendering and displaying risk of the virtual environment in a process of constructing the virtual environment.

For example, the prompt information is prompt information indicating that a quantity of vertexes of a collision body of the first virtual item in the first space exceeds the quantity threshold, and/or prompt information indicating that a data volume of texture resources of the first virtual item exceeds the quantity threshold.

Further, the prompt information further includes prompt information for global data in the virtual environment. For example, there is an excessively large quantity of virtual items in the virtual environment, motion devices are bound to the virtual items for movement, and there is an excessively large quantity of motion devices. It can be seen that the prompt information includes the prompt information for the global data in the virtual environment and the prompt information for the first space in the virtual environment, whereby a rendering and displaying risk of the virtual environment is prompted at different space granularities.

In an example, the hotspot region in FIG. 16 is based on voxel-based scene partitioning. The virtual environment is partitioned, and each voxel cube in the virtual environment is taken as a sampling region. Performance information of a plurality of factors is stored in each voxel cube, including at least one of parameter information such as a quantity of virtual items, a quantity of motion devices, translucent material overlaying, hard and transparent material overlaying, and collision bodies. The parameter information in each voxel is scored based on computational resource occupation, to obtain the first space at a rendering and displaying risk.

In an example, the parameter information in the voxel of the virtual environment may include rendering information such as material information. A material condition is predicted through ray sampling inside the voxel, to count quantities of meshes and translucent body materials in a scene. For example, aggregated information, such as a quantity of original surface patches within the voxel, is configured for estimating a quantity of geometrical surface patches on the same screen. The voxel of the virtual environment may include a density of collision bodies inside the voxel, to find a physically dense region in a scene. The voxel of the virtual environment may include a quantity of movable items inside the voxel.

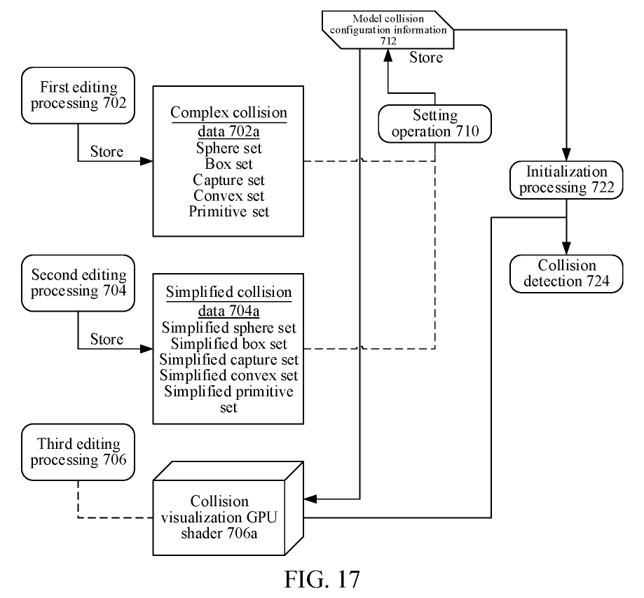

In one implementation, at least two levels of candidate collision bodies provided by a UGC editor are set in an offline editing stage. Two levels of candidate collision bodies are taken as an example. FIG. 17 is a schematic diagram of a collision body setting method of a virtual item according to an aspect of this disclosure. First editing processing 702 is configured for indicating that a first-level candidate collision body is stored as complex collision data 702a. For example, the complex collision data 702a is configured for indicating at least one of a sphere set, a box set, a capture set, a convex set, and a primitive set of the first-level candidate collision body. Second editing processing 704 is configured for indicating that a second-level candidate collision body is stored as simplified collision data 704a. For example, the simplified collision data 704a is configured for indicating at least one of a simplified sphere set, a simplified box set, a simplified capture set, a simplified convex set, and a simplified primitive set of the second-level candidate collision body. Third editing processing 706 refers to editing processing for a visualization graphics processing unit (GPU) shader. A collision visualization GPU shader 706a is generated through editing processing, and is stored in a storage device.

In a construction interface provided by the UGC editor, by using an interaction interface, any one in the at least two levels of candidate collision bodies provided by the UGC editor is selected through a setting operation 710, and a collision body of a virtual item is displayed by invoking the collision visualization GPU shader 706a based on the complex collision data 702a or simplified collision data 704a corresponding to the setting operation 710.

For example, model collision configuration information 712 is configured for storing any one in the at least two levels of candidate collision bodies indicated by the setting operation 710. It is determined, according to the model collision configuration information 712, that the collision visualization GPU shader 706a runs a collision visualization program based on the complex collision data 702a or the simplified collision data 704a. For example, in a running stage of the virtual environment, it is determined, according to the model collision configuration information 712, that initialization processing 722 is performed on data required for collision detection, and collision detection 724 of a virtual scene is performed based on the complex collision data 702a or the simplified collision data 704a.

FIG. 18 is a flowchart of a collision body setting method of a virtual item according to an aspect of this disclosure. The method includes:

Operation 752: Transmit a collision type to a data optimization model through a user interface (UI).

For example, the data optimization model is configured to store a collision type of a virtual item, and the collision type is attribute information of the virtual item.

Operation 754: The data optimization model modifies a collision type flag bit of a virtual item.

For example, the data optimization model modifies the collision type flag bit of the virtual item based on the collision type transmitted through the UI.

Operation 756: A UGC editor performs a trial run on a virtual environment.

For example, the UGC editor provides a trial-play function for performing a trail run on the virtual environment.

Operation 758: The UGC editor transmits a trial-play start event to the data optimization model.

The UGC editor transmits the trial-play start event to the data optimization model, to indicate that collision detection of the virtual item is set based on attribute information of the virtual item.

Operation 760: The data optimization model uses the collision type flag bit of the virtual item.

For example, the data optimization model performs collision detection on the virtual item in the virtual environment based on the collision type flag bit of the virtual item.

Operation 762: The UGC editor ends the trial run of the virtual environment.

The UGC editor stops the trial run of the virtual environment, and ends the trial-play function.

Operation 764: The UGC editor transmits a trial-play end event to the data optimization model.

The UGC editor transmits the trial-play end event to the data optimization model, to instruct the data optimization model to enter an editing state for the collision type flag of the virtual item.

Operation 766: The data optimization model resets the collision type flag bit of the virtual item.

For example, the data optimization model stops performing collision detection on the virtual environment, and is reset to enter an editing state for the collision type flag bit of the virtual item.

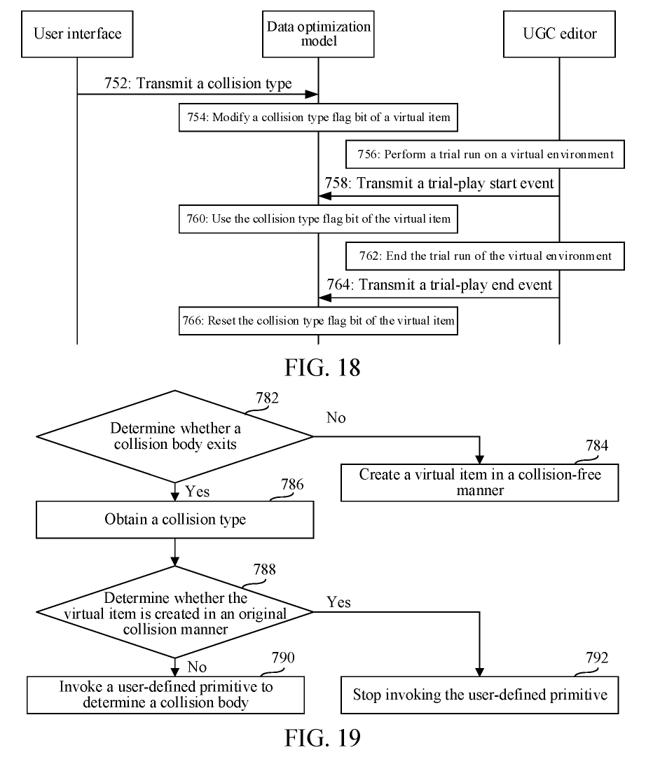

FIG. 19 is a flowchart of a collision body setting method of a virtual item according to an aspect of this disclosure. The method includes:

Operation 782: Determine whether a collision body exits.

For example, in a case that no collision body exists, operation 784 is performed; or in a case that a collision body exists, operation 786 is performed.

Operation 784: Create a virtual item in a collision-free manner.

For example, creating the virtual item in the collision-free manner is configured for indicating that collision detection is not performed on the virtual item.

Operation 786: Obtain a collision type.

For example, the collision type includes an original collision manner and a simple collision manner. For example, the original collision manner corresponds to a first-level candidate collision body, and the simple collision manner corresponds to a second-level candidate collision body. For example, the collision type is determined by setting a field.

Operation 788: Determine whether the virtual item is created in an original collision manner.

For example, whether the virtual item is created in the original collision manner is determined according to the obtained collision type. For example, in a case that the virtual item is created in the original collision manner, operation 792 is performed; or in a case that the virtual item is not created in the original collision manner, operation 790 is performed.

Operation 790: Invoke a user-defined primitive to determine a collision body.

For example, the user-defined primitive is configured for encapsulating simple collision data, and the simple collision corresponds to the user-defined primitive of collision in a mesh. For example, by setting a use field of the user-defined primitive to Yes, the user-defined primitive is invoked.

Operation 792: Stop invoking the user-defined primitive.

For example, a complex collision corresponds to a primitive of collision in a mesh, and invoking the user-defined primitive is stopped to determine a collision body. For example, by setting the use field of the user-defined primitive to No, invoking the user-defined primitive is stopped.

In conclusion, in the method provided in the aspects of this disclosure, by providing the at least two levels of candidate collision bodies corresponding to different amounts of occupied computational resources for the virtual item, a determination manner of the collision body of the virtual item is expanded. The at least two levels of candidate collision bodies correspond to different quantities of vertexes, whereby the at least two levels of candidate collision bodies correspond to different amounts of occupied computational resources. In this way, the computational resource occupation can be adjusted based on different quantities of vertexes, and a purpose of flexibly configuring collision bodies to terminals with different computing capabilities can be achieved.

A person of ordinary skill in the art may understand that the foregoing aspects may be implemented independently, or the foregoing aspects may be combined in different manners to form new aspects for implementing the collision body setting method of a virtual item of this disclosure.

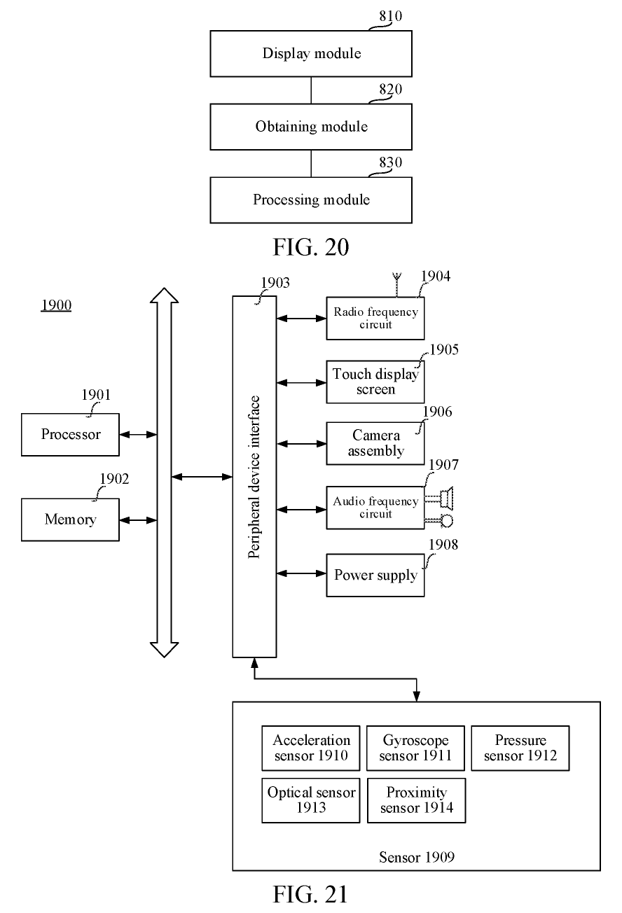

FIG. 20 is a structural block diagram of a collision body setting apparatus of a virtual item according to an aspect of this disclosure. The apparatus runs a game program, the game program has a UGC editor, and the UGC editor is at least configured to enable creation of a user-defined virtual environment. The apparatus includes:

a display module 810, configured to display a construction interface of the UGC editor, the construction interface including at least one virtual item configured for constructing a virtual environment, and the UGC editor providing at least two levels of candidate collision bodies for the virtual item; and

an obtaining module 820, configured to obtain a setting operation for the virtual item, the setting operation being configured for indicating that a first candidate collision body in the at least two levels of candidate collision bodies is determined as a collision body of the virtual item,

the display module 810 being further configured to display the collision body of the virtual item in response to the setting operation; and

a quantity of vertexes of an i^{th}-level candidate collision body in the at least two levels of candidate collision bodies being a first quantity, a quantity of vertexes of an (i+1)^{th}-level candidate collision body in the at least two levels of candidate collision bodies being a second quantity, the first quantity being greater than the second quantity, and i being a positive integer less than a quantity of candidate collision bodies.

In one implementation of the aspects, the setting operation includes a first trigger operation for a first selection control and a second trigger operation for a collision body viewing control; and

the display module 810 is further configured to:

display the collision body viewing control of the virtual item in response to the first trigger operation, the collision body viewing control being configured for providing a function entry for viewing the first candidate collision body corresponding to the first selection control; and

display the collision body of the virtual item in response to the second trigger operation for the collision body viewing control,

the construction interface including at least two candidate selection controls, the at least two candidate selection controls including the first selection control, and the at least two candidate selection controls being in one-to-one correspondence with the at least two levels of candidate collision bodies.

In one implementation of the aspects, the virtual item is an item created in the virtual environment; and the display module 810 is further configured to:

display the collision body on the virtual item in the virtual environment in an overlaying manner in response to the setting operation.

In one implementation of the aspects, the virtual item is a candidate item provided on the construction interface; and the display module 810 is further configured to:

display an initial label of the virtual item as a first label in response to the setting operation, the first label being configured for indicating that the virtual item corresponds to the collision body.

In one implementation of the aspects, the obtaining module 820 is further configured to create an environment constructing item in the virtual environment in response to obtaining a creation operation for the virtual item, a type of the environment constructing item being the same as a type of the virtual item; and

the display module 810 is further configured to display a collision body of the environment constructing item in response to obtaining a viewing operation for the environment constructing item.

In one implementation of the aspects, a vertex of the collision body includes at least one of the following:

a vertex position of the collision body belongs to a subset of vertex positions of the virtual item;

in a case that a first plane on which at least three vertexes of the collision body are located penetrates through the virtual item, a maximum distance between a first vertex of the virtual item and the first plane is less than a first distance threshold, and the first vertex is any vertex located on a first side of the first plane;

in a case that a second plane on which at least three vertexes of the collision body are located does not penetrate through the virtual item, a minimum distance between a second vertex of the virtual item and the second plane is less than a second distance threshold, and the second vertex is any vertex on the virtual item; and

a distance between any two vertexes of the collision body is greater than a third distance threshold.

In one implementation of the aspects, the collision body includes at least one of a cuboid collision body, a spherical collision body, and a polygonal surface patch; and

in a case that the collision body includes the cuboid collision body, a vertex of the collision body includes a vertex of the cuboid collision body;

in a case that the collision body includes the spherical collision body, a vertex of the collision body includes a vertex of the spherical collision body on coordinate axes of a three-dimensional coordinate system, and the three-dimensional coordinate system is established by taking a spherical center of the spherical collision body as an origin; or

in a case that a surface of the collision body includes the polygonal surface patch, a vertex of the collision body includes a vertex of the polygonal surface patch.

In one implementation of the aspects, the obtaining module 820 is further configured to:

obtain a combination operation for at least two virtual models, the combination operation being configured for indicating that the at least two virtual models are grouped; and

the display module 810 is further configured to:

display the construction interface including the virtual item in response to the combination operation, the virtual item being a combination obtained by grouping the at least two virtual models.

In one implementation of the aspects, the collision body of the virtual item is a cuboid collision body, a vertex of the collision body is a vertex of the cuboid collision body, a bottom surface of the cuboid collision body is a minimum bounding rectangle of a projection of the virtual item in a vertical direction, and a height of the cuboid collision body is a height of the virtual item; or

a vertex of the collision body of the virtual item is a vertex on a surface of a three-dimensional region formed by collision bodies of the at least two virtual models.

In one implementation of the aspects, the apparatus further includes:

a processing module 830, configured to change a position of the virtual item in the virtual environment in response to a dragging operation for the collision body.

In one implementation of the aspects, the display module 810 is further configured to:

display prompt information in a case that a quantity of first virtual items in a first space in the virtual environment exceeds a quantity threshold, the prompt information being alarm information indicating that the quantity of first virtual items exceeds the quantity threshold.

In one implementation of the aspects, the display module 810 is further configured to:

display the prompt information in a case that a quantity of vertexes of a collision body of the first virtual item exceeds the quantity threshold;

or

display the prompt information in a case that a data volume of texture resources of the first virtual item exceeds the quantity threshold.

In one implementation of the aspects, a display manner of the prompt information includes at least one of the following:

displaying the prompt information by using a highlighted mark of the first space;

displaying the prompt information by using a pop-up window;

displaying the prompt information by using a bubble; and

displaying the prompt information by using a pop-up message card.

When the apparatus provided in the foregoing aspects implements the functions of the apparatus, division of the foregoing various functional modules is merely used as an example for description. In practical application, the foregoing functions may be distributed to and implemented by different functional modules according to actual needs. That is, a content structure of a device is divided into different functional modules, to implement all or some of the functions described above.

Specific manners of performing operations by the modules of the apparatus in the foregoing aspects have been described in detail in the aspects related to the method. Technical effects obtained by performing the operations by the modules are the same as the technical effects in the aspects related to the method, and details are not described here again.

The aspects of this disclosure further provide a computer device. The computer device includes: a processor and a memory. The memory has a computer program stored therein; and the processor is configured to execute the computer program in the memory to implement the collision body setting method of a virtual item provided in the foregoing method aspects.

FIG. 21 is a structural block diagram of a terminal according to an aspect of this disclosure. A terminal 1900 may be a smartphone, a tablet computer, an MP3 player, an MP4 player, a notebook computer, or a desktop computer. The terminal 1900 may alternatively be referred to as another name such as a user device, a portable terminal, a laptop terminal, or a desktop terminal.

Typically, the terminal 1900 includes a processor 1901 (an example of processing circuitry) and a memory 1902 (an example of a non-transitory computer-readable storage medium). The processor 1901 may include one or more processing cores, such as a 4-core processor or an 8-core processor. The processor 1901 may be implemented in at least one hardware form of a digital signal processor (DSP), a field-programmable gate array (FPGA), and a programmable logic array (PLA). The processor 1901 may alternatively include a main processor and a coprocessor. The main processor is a processor configured to process data in an awake state, and is also referred to as a central processing unit (CPU). The coprocessor is a low power consumption processor configured to process data in a standby state. In some aspects, the processor 1901 may be integrated with a GPU. The GPU is configured to render and draw content that needs to be displayed on a display screen. In some aspects, the processor 1901 may further include an artificial intelligence (AI) processor. The AI processor is configured to process computing operations related to machine learning.

The memory 1902 may include one or more computer-readable storage media. The computer-readable storage medium may be non-transitory. The memory 1902 may further include a high-speed random-access memory and a non-volatile memory, such as one or more disk storage devices or flash storage devices. In some aspects, the non-transitory computer-readable storage medium in the memory 1902 is configured to store at least one instruction. The at least one instruction is executed by the processor 1901 to implement the collision body setting method of a virtual item provided in the method aspects of this disclosure.

In some aspects, the terminal 1900 may further include: a peripheral device interface 1903 and at least one peripheral device. The processor 1901, the memory 1902, and the peripheral device interface 1903 may be connected through a bus or a signal cable. Each peripheral device may be connected to the peripheral device interface 1903 through a bus, a signal cable, or a circuit board. For example, the peripheral device includes at least one of a radio frequency circuit 1904, a touch display screen 1905, a camera assembly 1906, an audio frequency circuit 1907, and a power supply 1908.

In some aspects, the terminal 1900 further includes one or more sensors 1909. The one or more sensors 1909 include, but are not limited to, an acceleration sensor 1910, a gyroscope sensor 1911, a pressure sensor 1912, an optical sensor 1913, and a proximity sensor 1914.

A person skilled in the art may understand that the foregoing structure is not intended to be constructed as limiting the terminal 1900, and the terminal may include more or fewer components than those shown in the figure, or some components may be combined, or a different component deployment may be adopted.

In an aspect, a chip is further provided. The chip includes a programmable logic circuit and/or program instructions. When run on a computer device, the chip is configured to implement the collision body setting method of a virtual item according to the foregoing aspect.

In an aspect, a computer program product, such as a non-transitory computer-readable storage medium, is further provided. The computer program product includes computer-readable instructions, and the computer-readable instructions are stored in a computer-readable storage medium. A processor of a computer device reads the computer-readable instructions from the computer-readable storage medium and executes the computer-readable instructions, to implement the collision body setting method of a virtual item provided in the foregoing method aspects.

In an aspect, a computer-readable storage medium is further provided. The computer-readable storage medium has a computer program stored herein, and the computer program is loaded and executed by a processor to implement the collision body setting method of a virtual item provided in the foregoing method aspects.

It is noted that all or some of the operations of the foregoing aspects may be implemented by using hardware, or may be implemented by a program instructing relevant hardware. The program may be stored in a computer-readable storage medium. The storage medium mentioned above may be a read-only memory, a magnetic disk, an optical disc, or the like.

It is noted that in the foregoing one or more examples, the functions described in the aspects of this disclosure may be implemented by using hardware, software, firmware, or any combination thereof. When implemented by using software, the functions may be stored in a computer-readable medium or may be transmitted as one or more instructions or code in a computer-readable medium. The computer-readable medium includes a computer storage medium and a communication medium. The communication medium includes any medium that enables a computer program to be transmitted from one place to another. The storage medium may be any available medium accessible to a general-purpose or dedicated computer.

The foregoing descriptions are merely some aspects of this disclosure, and are not intended to limit this disclosure. Any modification, equivalent substitution, improvement, and the like made within the spirit and principle of this disclosure falls within the scope of this disclosure.

What is claimed is:

1. A collision body setting method of a virtual item, the method comprising:
outputting for display, by processing circuitry, a construction interface of a user generated content (UGC) editor, the construction interface including a virtual item construction element of a virtual item to be constructed in a virtual environment, the UGC editor generating at least two levels of candidate collision bodies for the virtual item;
obtaining a setting operation that indicates a first level of candidate collision body among the at least two levels of candidate collision bodies to be associated with a collision body of the virtual item; and
outputting for display the collision body of the virtual item based on the setting operation, wherein
a quantity of vertices of an i^{th}-level candidate collision body of the at least two levels of candidate collision bodies is a first quantity, a quantity of vertices of an (i+1)^{th}-level candidate collision body of the at least two levels of candidate collision bodies is a second quantity, and the first quantity is greater than the second quantity, i being a positive integer smaller than a total quantity of the candidate collision bodies.

2. The method according to claim 1, wherein the obtaining the setting operation comprises:
receiving a first trigger operation performed on a first selection control element of the construction interface; and
receiving a second trigger operation performed on a collision body viewing control element of the construction interface, wherein
the construction interface includes (i) the first selection control element corresponding to a first level of candidate collision body of the at least two levels of candidate collision bodies, and (ii) a second selection control element corresponding to a second level of candidate collision body of the at least two levels of candidate collision bodies.

3. The method according to claim 1, wherein the outputting for display the collision body of the virtual item comprises:
outputting for display the collision body with the virtual item in the virtual environment.

4. The method according to claim 1, wherein the virtual item is a candidate item generated via the construction interface, and the outputting for display the collision body of the virtual item comprises:
outputting for display an initial label of the virtual item, the initial label indicating the virtual item corresponds to the collision body.

5. The method according to claim 1, further comprising:
adding the virtual item to the virtual environment based on a creation operation performed on the virtual item construction element in the construction interface; and
outputting for display, based on a viewing operation performed on the virtual item added to the virtual environment, the collision body of the virtual item.

6. The method according to claim 1, wherein vertex positions of the collision body include a subset of vertex positions of the virtual item.

7. The method according to claim 1, wherein
the collision body includes at least one of a cuboid collision body, a spherical collision body, and a polygonal surface patch;
when the collision body includes the cuboid collision body, vertices of the collision body include vertices of the cuboid collision body;
when the collision body includes the spherical collision body, vertices of the collision body include vertices of the spherical collision body on coordinate axes of a three-dimensional coordinate system, an origin of the three-dimensional coordinate system being a center of the spherical collision body; and
when a surface of the collision body includes the polygonal surface patch, vertices of the collision body include vertices of the polygonal surface patch.

8. The method according to claim 5, further comprising:
obtaining a combination operation performed on at least two virtual models, the combination operation indicating that the at least two virtual models are grouped; and
outputting for display, based on the combination operation, a combined virtual item construction element of a combined virtual item obtained by grouping the at least two virtual models.

9. The method according to claim 8, wherein the combined virtual item is associated with a cuboid collision body, a bottom surface of the cuboid collision body being a minimum bounding rectangle of a projection of the combined virtual item in a vertical direction, and a height of the cuboid collision body being a height of the combined virtual item.

10. The method according to claim 8, wherein vertices of the collision body of the combined virtual item are vertices on a surface of a three-dimensional region formed by collision bodies of the at least two virtual models.

11. The method according to claim 5, further comprising:
changing a position of the virtual item added to the virtual environment based on a dragging operation performed on the collision body of the virtual item.

12. The method according to claim 5, further comprising:
outputting for display notification information based on a quantity of a plurality of virtual items in a first space of the virtual environment exceeding a quantity threshold, the notification information indicating that the quantity of virtual items exceeds the quantity threshold.

13. The method according to claim 12, wherein the outputting for display the notification information comprises:
outputting for display the notification information based on a quantity of vertices of collision bodies respectively associated with the plurality of virtual items exceeding the quantity threshold;
or
outputting for display the notification information based on a data volume of texture resources of the plurality of virtual items exceeding the quantity threshold.

14. An information processing apparatus, comprising:
processing circuitry configured to:
output for display a construction interface of a user generated content (UGC) editor, the construction interface including a virtual item construction element of a virtual item to be constructed in a virtual environment, the UGC editor being configured to generate at least two levels of candidate collision bodies for the virtual item;
obtain a setting operation that indicates a first level of candidate collision body among the at least two levels of candidate collision bodies to be associated with a collision body of the virtual item; and
output for display the collision body of the virtual item based on the setting operation, wherein
a quantity of vertices of an i^{th}-level candidate collision body of the at least two levels of candidate collision bodies is a first quantity, a quantity of vertices of an (i+1)^{th}-level candidate collision body of the at least two levels of candidate collision bodies is a second quantity, and the first quantity is greater than the second quantity, i being a positive integer smaller than a total quantity of the candidate collision bodies.

15. The apparatus according to claim 14, wherein the processing circuitry is configured to:
receive a first trigger operation performed on a first selection control element of the construction interface; and
receive a second trigger operation performed on a collision body viewing control element of the construction interface, wherein
the construction interface includes (i) the first selection control element corresponding to a first level of candidate collision body of the at least two levels of candidate collision bodies, and (ii) a second selection control element corresponding to a second level of candidate collision body of the at least two levels of candidate collision bodies.

16. The apparatus according to claim 14, wherein the processing circuitry is configured to:
output for display the collision body with the virtual item in the virtual environment.

17. The apparatus according to claim 14, wherein the virtual item is a candidate item generated via the construction interface, and the processing circuitry is configured to:
output for display an initial label of the virtual item, the initial label indicating the virtual item corresponds to the collision body.

18. The apparatus according to claim 14, wherein the processing circuitry is configured to:
add the virtual item to the virtual environment based on a creation operation performed on the virtual item construction element in the construction interface; and
output for display, based on a viewing operation performed on the virtual item added to the virtual environment, the collision body of the virtual item.

19. The apparatus according to claim 14, wherein vertex positions of the collision body include a subset of vertex positions of the virtual item.

20. A non-transitory computer-readable storage medium storing instructions which, when executed by a processor, cause the processor to perform:
outputting for display a construction interface of a user generated content (UGC) editor, the construction interface including a virtual item construction element of a virtual item to be constructed in a virtual environment, the UGC editor generating at least two levels of candidate collision bodies for the virtual item;
obtaining a setting operation that indicates a first level of candidate collision body among the at least two levels of candidate collision bodies to be associated with a collision body of the virtual item; and
outputting for display the collision body of the virtual item based on the setting operation, wherein a quantity of vertices of an i^{th}-level candidate collision body of the at least two levels of candidate collision bodies is a first quantity, a quantity of vertices of an (i+1)^{th}-level candidate collision body of the at least two levels of candidate collision bodies is a second quantity, and the first quantity is greater than the second quantity, i being a positive integer smaller than a total quantity of the candidate collision bodies.
